(19) United States
(12) Patent Application Publication
(10) Pub. No.: US 2008/0027971 A1
(43) Pub. Date: Jan. 31, 2008

(54) Method and system for populating an index corpus to a search engine

(76) Inventor: Craig Statchuk, North Gower (CA)

Correspondence Address: PEARNE & GORDON LLP, 1801 EAST 9TH STREET, SUITE 1200, CLEVELAND, OH, 44114-3108, US

(21) Appl. No.: 11/494,975

(22) Filed: Jul. 28, 2006

(51) Int. Cl. G06F 17/00

(52) U.S. Cl. 707/102

(57) ABSTRACT

A method and system is provided for populating an index corpus to an external search engine. The index population system comprises a card generator and a file system. The card generator reads a target content instance of business oriented metadata, and creates a representation of the target content instance. The card generator generates an index summary card for storing the representation of the target content instance. In an embodiment, the index summary card is in an HTML format that is consumable by various search engines. The file system stores the index summary cards and exposes the index summary card to an external search engine.

### FIELD OF INVENTION

The present invention relates to a metadata content management and searching system and method, especially to a method and system for populating an index corpus to a search engine.

### BACKGROUND OF THE INVENTION

Competitive economies motivate business managers and other users to obtain maximum value from their investments for Corporate Performance Management (CPM) tools, such as Business Intelligence (BI) tools, that are used to manage business oriented data and metadata. These CPM tools provide authored reports or authored drill-through targets to link content together. Users often encounter similar problems in finding important reports or relevant data or drilling to related content if it was not previously authored.

Traditional search technologies often provide incomplete or irrelevant results in the CPM environments. There are metadata search tools that run against relational databases. They can fail to find relevant data since they only search databases and do not leverage a customer's investment in CPM tools and applications. Relying on authored drill-through targets can also be problematic as new cube, reports, metrics or plans are added since new drill targets are not always kept up-to-date. Users can have difficulties moving seamlessly between CPM tools or applications, particularly when CPM applications are created by different individuals or departments.

It is therefore desirable to provide a mechanism that allows more effective searches of business oriented metadata content.

There exist search engines that use a full-text index combined with statistical methods to create ordered search results. An example of such a search engine is page ranking that is described in U.S. Pat. No. 6,526,440 issued to Bharat. However, these search engines are not sufficient to search complex data like business oriented metadata since they rely on ranking algorithms that work with data found primarily in the Global Internet and not inside a business.

In order to use an existing search engine for searching business oriented metadata, references to the relevant metadata content need to be added to the index that the search engine uses. Adding content references to an external index is complicated as there are hundreds of search engine choices available. No viable standards exist to allow promotion of content to all of these search engines. Each search engine potentially requires a different methods for populating its index with content, organizing content, rating search results, and adding security to search results. Generic content is normally used to leverage positive results in as many search engines as possible. However, specific content for a given search engine is needed to leverage positive results in a particular search engine or engines when generic content is not sufficient. Engine-specific data is particularly needed when passing information like security requirements because no generic standards exist.

Traditionally, programmers use Application Program Interfaces (APIs) to populate indexes directly to a particular search engine. Most API's are specific to a particular search engine thereby making it difficult to target multiple search engines.

Some search engines routinely use “crawlers” to roam through Internets and Intranets looking for content to index. Programmers can write “software adapters” to help crawlers understand different types of content. For example, adapters are written for Word and PDF documents. Like search engine API's, these adapters are normally specific to a limited number of search engines, and cannot be used for multiple search engines.

Related indexing standards include Object Windows Library (OWL) and Resource Description Framework (RDF). As of this date, neither has the richness or flexibility required to adequately index complex data like business oriented metadata.

It is therefore desirable to provide a mechanism that allows population of an external index corpus to multiple types of search engines.

### SUMMARY OF THE INVENTION

It is an object of the invention to provide an improved metadata content management system that obviates or mitigates at least one of the disadvantages of existing systems.

The invention uses index summary cards to store representations of target content instances in business oriented metadata.

In accordance with an aspect of the present invention, there is provided an index population system for populating an index corpus to an external search engine. The index population system comprises a card generator and a file system. The card generator is provided for reading business oriented metadata, and for each target content instance in the business oriented metadata, creating a representation of the target content instance, and generating an index summary card for storing the representation of the target content instance. The index summary card is in a format that is consumable by various search engines. The file system is provided for storing one or more index summary cards and exposing the index summary cards to an external search engine.

In accordance with another aspect of the invention, there is provided a method of populating an index corpus to one or more external search engines. The method comprises the steps of reading a target content instance of business oriented metadata; creating a representation of the target content instance; generating an index summary card using the representation of the target content instance, the index summary card being in a format that is consumable by various search engines; and exposing the index summary card to an external search engine.

In accordance with another aspect of the invention, there is provided a computer readable medium storing instructions or statements for use in the execution in a computer of a method of populating an index corpus to one or more external search engines. The method comprises steps of reading a target content instance of business oriented metadata; creating a representation of the target content instance; generating an index summary card using the representation of the target content instance, the index summary card being in a format that is consumable by various search engines; and exposing the index summary card to an external search engine.

In accordance with another aspect of the invention, there is provided a propagated signal carrier carrying signals containing computer executable instructions that can be read and executed by a computer, the computer executable instructions being used to execute a method of populating an index corpus to one or more external search engines. The method comprises the steps of reading a target content instance of business oriented metadata; creating a representation of the target content instance; generating an index summary card using the representation of the target content instance, the index summary card being in a format that is consumable by various search engines; and exposing the index summary card to an external search engine.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a metadata content management system in accordance with an embodiment of the present invention;

FIG. 2 is a block diagram showing an embodiment of the metadata content management system;

FIG. 3 is a block diagram showing an embodiment of a content index component;

FIG. 4 is a diagram showing metadata and report values;

FIG. 5 is a block diagram showing an embodiment of an index population system; and

FIG. 6 is a flowchart showing a method of generating index summary cards.

### DETAILED DESCRIPTION

Referring to FIG. 1, a metadata content management system 10 in accordance with an embodiment of the invention is described. The metadata content management system 10 is suitably used for an enterprise or other organization that has sources of business oriented information, i.e., business oriented metadata 20. The metadata content management system 10 interacts with the business oriented metadata 20, as well as one or more search tools or components 30 and user reporting applications 40 used by the organization.

An organization typically has untapped sources of information, e.g., business oriented metadata 20 including reporting metadata 21 and specifications and key report values 22 of the user reporting applications 40. The business oriented metadata 20 includes OLAP and dimensional business data defined by the user reporting applications 40. These information, metadata and values may be collectively called as business oriented metadata 20 in this specification.

The metadata content management system 10 indexes the content of the business oriented metadata 20. It analyzes the business oriented metadata 20 to create a search index. Since the search index is created from the organization's metadata 20, it is suitable for the organization. By providing such a search index, the metadata content management system 10 promotes navigation between BI tools 30 and reporting applications 40, creating a strategic view of CPM assets. The metadata content management system 10 captures application context, e.g., “viewing location” or “query parameters”, by creating the search index from the reporting metadata 21. The search index created by the metadata content management system 10 enables many unique navigation options beyond traditional folder browsing and text searching.

As shown in FIG. 4, a typical organization has various data sources 39, such as operational databases and/or data warehouses, and several CPM tools or user reporting applications 40 that create cubes and/or report specifications 41 and generate reports 42. Reporting metadata 21 and associated values 22 are produced by those applications 40. Other business oriented metadata may be exported from metadata modeling tools. While authoring reports in reporting applications 40, the creation of new hierarchies and data definitions occur. These hierarchies and data definitions are useful for drilling and searching. This data is often more recognizable to end-users since this is the data or text that the users see in applications 40 and their reports 41. These metadata and report data are considered as extended metadata 21 to describe the metadata created by different authoring and processing phases. Extended report data 22 refers to values created in a similar fashion.

These extended metadata 21 and report data 22 can be viewed as new BI data or business oriented metadata 20 of the organization. The metadata content management system 10 leverages the new BI data 20 to provide searching and drilling that was previously unavailable in existing systems, as described below.

Examples of extended metadata 21 added by the authoring process includes dimension names, dimension levels, category names, alternate category names, cube hierarchies, table and record names, group names, parent/child relationships between categories, groups or tables, authored drill target names, CPM tool's model entities such as packages, namespaces, query items, query sources and relevant authored relationships. Examples of extended authored report values 22 include items related by one of more dimensions, categories, measures groups or tables, calculated values, and annotations.

For example, a BI tool may provide dimensional business data, such as crosstable providing dimension, category and measure names. These names represent extended metadata 21. These names may or may not match table/column names in a star schema or other relational model. Yet each of these names represents an important potential target for drilling or searching. Values stored in a cube, including calculated values, represent extended data or values 22. They are a valuable target for searching. Like extended metadata 21, many of these values 22 are not found in any other data store.

Another example of a reporting tool 40 may provide a report with columns. In such a report, each of the column heading represents extended metadata 21. The report grouping, e.g., by country, represents another form of extended metadata 21. Report values themselves represent extended report data 22. They offer important linking and search targets.

In these cases, the extended metadata names are the same as those viewed by the report user. Thus, these extended metadata names are often most relevant and recognizable to the report user. Using these metadata names allows the metadata content management system 10 to provide information relevant and recognizable to the report user. These metadata names may or may not match the names used in the underlying databases.

Authored links, such as those anchored to the column name “Sales Rep Name”, provide additional summary information about the linked reports. This information also represents extended metadata 21. This information allows the metadata content management system 10 to further increase search relevance about the destination content of the metadata 20 including the metadata 21 or report values 22.

The metadata content management system 10 indexes content of the business oriented metadata 20 and generates a content index or index corpus which is a searchable database of representations of the content of the business oriented metadata 20, as further described below.

Research related to data searching and linking technologies commonly identifies two basic types of data: structured data and unstructured data. Structured data is defined by a formal schema. Typically structured data is searched with utilities of Online Analytical Processing (OLAP), Structured Query Language (SQL) and eXtensible Markup Language (XML). Unstructured data is normally found in documents and static web pages. Typically unstructured data is searched using free-form queries with web tools, such as Google™.

The content index provides various advantages. The metadata content management system 10 enhances search and drill-through capabilities across the range of user report applications 40 without requiring drill-through authoring in source content. A report author simply publishes target reports and lets the metadata content management system 10 find drill locations to the target content.

The metadata content management system 10 organizes business oriented metadata content in ways that are more relevant and meaningful to users. The metadata content management system 10 also includes several personalization and administration options.

The metadata content management system 10 describes data using names and labels from actual reports. These names are often more familiar and relevant to report users. The metadata content management system 10 also provides enhanced report-to-report drilling and product-to-product navigation. It expands the number of places where report users can “drill-to” and “drill-from” in a report. Most drilling requires no advance authoring. The metadata content management system 10 improves the capabilities of search tools. This includes the concept of ‘federated’ search across a variety of portal and web search indices.

User reporting applications 40 often generate authored relational and OLAP reports. Those reports provide a wealth of new metadata, including schema information, that is largely hidden from other tools and reporting applications. The metadata content management system 10 exposes this metadata in a standard format that can be re-used by other CPM applications 40 and tools 30.

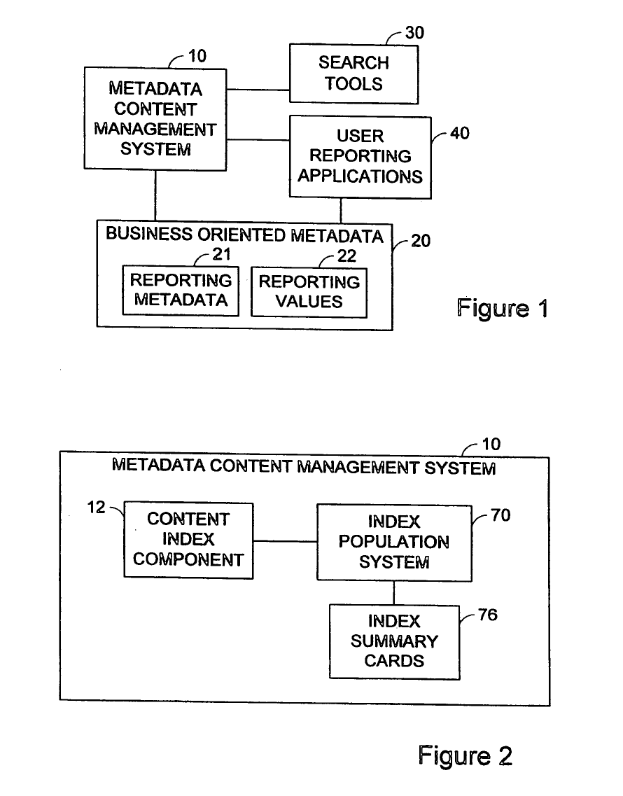

FIG. 2 shows an embodiment of the metadata content management system 10. The metadata content management system 10 has a content index component 12.

The metadata content management system 10 uses indexing so that the metadata content can be searched and organized in real-time. Indexing is normally performed by the metadata content management system 10 when the metadata content is published or updated. Indexing can be performed by a scheduled administrator task (example: nightly cron job). It can also be performed manually by an administrator or user.

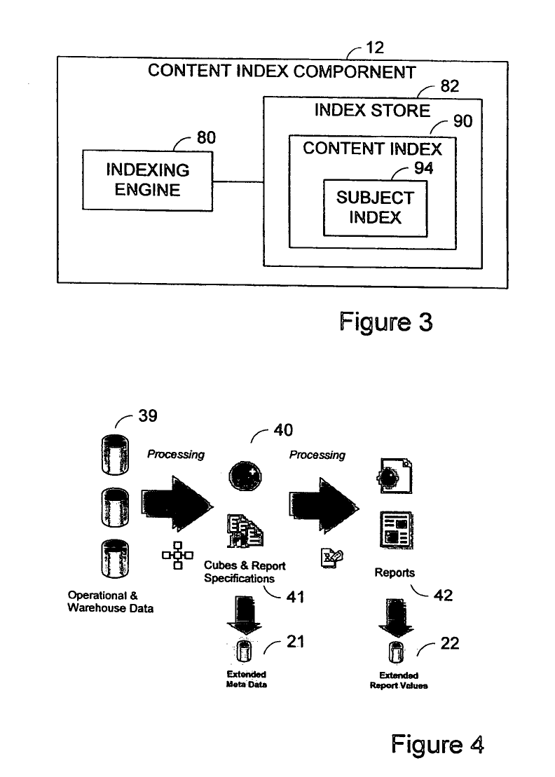

As shown in FIG. 3, the content index component 12 has an indexing engine 80 and an Index store 82. The index store 82 stores files for content index 90. The content index 90 may also be called an index corpus or knowledge base. The content index 90 is a full-text index.

The indexing engine 80 performs indexing of the content of the business oriented metadata 20 for a particular organization. It analyzes the content of the business oriented metadata 20 and creates indexes as described below. Since it creates indexes from the business oriented metadata of the organization, the created indexes are suitable for the organization.

A single set of index files is typically maintained in the index store 82 in the content index component 12 for all users and user groups for the organization. By storing a single set of index files in a single store, the metadata content management system 10 can provide optimal or improved performance. The index store 82 may be part of a server file system of the organization.

A content index 90 is a collection of content indexes. In other words, the content index 90 is a concordance of unique words (called terms) across scanned or indexed content items (called documents). Each content index contains an entry for each term across the indexed documents. Each context index catalogs individual words or terms and stores them along with their usage or other data. Each indexed content term contains a list of the indexed documents that have that term. Each indexed content term also contains usage statistics and the position of the term within each indexed document where possible. A content index is an “inverted index” where each indexed term refers to a list of documents that have the indexed term, rather than each indexed document contains a list of terms as in traditional indexes. The content index 90 provides term searches and links to additional data stored in the content index 90. Each content index may contain, for each content, i.e., target item, information regarding the name or identification of the target item; module, cube or report metadata and their relevant metadata hierarchy; item location in the document folder hierarchy; and/or reference to its dependent model.

A content index may be an XML content index that describes each indexed item in XML. An XML content index stores applicable metadata, metrics and planning information that improve search relevance. Each XML content index is associated with each indexed document. An indexed document is an XML file that catalogs metadata, report values and other reporting application-specific information.

The XML content index items or data are stored in flat files in the index store 82. The index store 82 may be the application server's file system. A relational database can optionally be configured to store this XML content index data. “Read” activity related to XML content index items is low compared to typical full-text index items. Records of XML content index items are read by search tools 30.

While FIG. 3 shows the index store 82 within the content index component 12, the index store 82 may or may not be part of the metadata content management system 10.

The content index 90 may be stored in application server flat files. The content index 90 is typically optimized to minimize disk reads and keep term storage as low as possible. The content index 90 may be stored in a data store of an external full-text search engine. For example, the metadata content management system 10 may use an implementation of an existing full-text engine, e.g., the open source Apache Jakata Lucene full-text engine.

The content index 90 also includes a taxonomy or subject index 94. The subject index 94 may also be called a subject hierarchy, topic hierarchy, topic tree or subject dictionary. The subject index 94 is a collection of indexes, each being a file-based index extension that allows subject hierarchies or taxonomies to be quickly queried. The subject index 94 allows searches of parent topic names for a given term, as further described below.

As shown in FIG. 2, the metadata content management system 10 also has an index population system 70.

The index population system 70 is used for populating the external search engine or tool 30 with an index corpus that allows content referenced by each index to be found by that search engine 30. The content of business oriented metadata 20 is a collection of original content instances. For example, authored data is an example business oriented data, like OLAP and relational data. It can be searched for subject hierarchies and can be the targeted for searching. Users often want to view such authored data as the result of a search.

As the index management system 10 and external search engines 30 may be made by different manufactures based on different systems, external search engines 30 often cannot use an index corpus created by the index management system 10. The index corpus created by the index management system 10 needs to be populated to external search engines 30. The index population system 70 makes it easy to populate external search engines 30 with references to content instances of business oriented metadata 20 so that the content instances can be found when appropriate queries are provided by a user or reporting applications 40 (collectively called operators).

The index population system 70 is now described in detail. The index population system 70 uses index summary cards 76 to store representations of targeted content instances of the business oriented metadata 20. These index summary cards 76 allow the targeted content instances in the business oriented metadata 20 to be easily indexed and subsequently found by search engines 30. Each index summary card 76 contains summaries of target or referenced content instances. These summaries include terms, topic hierarchies, report metadata, related information and URIs needed to show the content instances. The index population system 70 typically stores index summary cards 76 separately from the content index or knowledge base documents 54 described above. The index summary cards 76 are generated and placed on a file system for the purpose of letting external search engines 30 find them.

The information of the index summary cards 76 is provided in formats that are easily consumed by different search engines 30. For example, the index summary cards may be in standard HyperText Markup Language (HTML) files. Since the index summary cards 76 are in standard formats or formats easily consumed, the information of the index summary cards 76 is not necessarily specific to any single search engine 30.

Also, redundant presentation of data using different formats is used in an index summary card 76 to increase the number of search engines 30 that can effectively consume its content. For example, the index population system 70 may generate an index summary card 76 for a content instance in HTML, XML, Resource Description Framework (RDF)-XML, and plain-text. Different embodiments may use a different combination of these or other standard formats.

Security restrictions may also be applied to referenced content instances and they are reflected in each summary card 76. This allows external search engines 30 to apply a similar security restriction to the lists of results that they show.

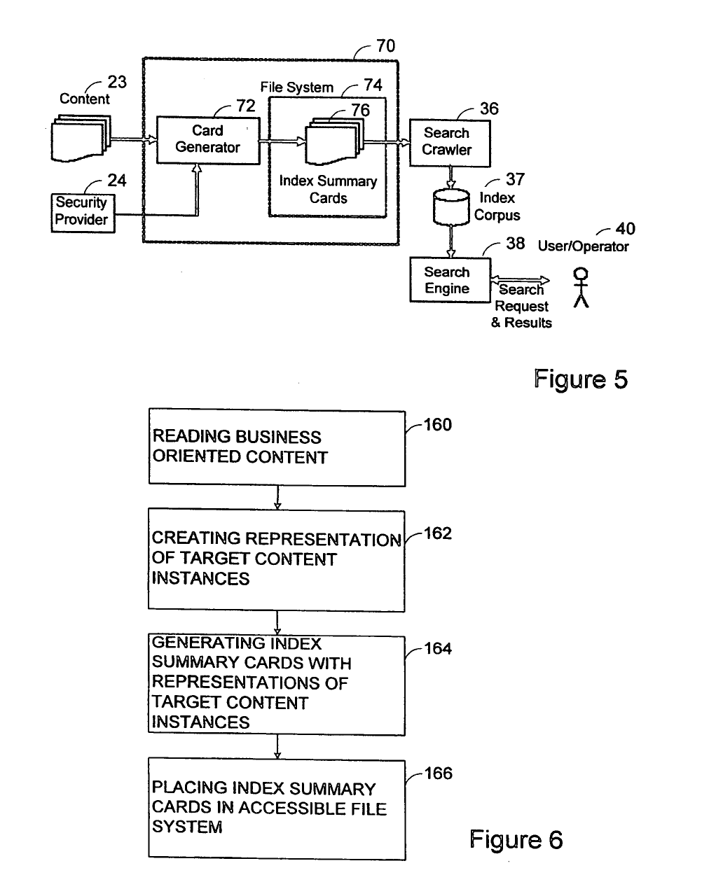

Referring to FIG. 5, an embodiment of the index population system 70 is further described. The index population system 70 comprises a card generator 72, and a file system 74 containing index summary cards 76. The card generator 72 is a component that reads referenced content details, produces index summary card content references, and generates index summary cards 76 from the current index.

The card generator 72 may be a separate Java application that generates HTML summary cards 76. Each HTML summary card 76 includes HTML to forward the current page to referenced content, hidden terms XML and meta tags, XML representation of content structure, and boiler-plate text from a standard template. HTML and web files have hidden content that a browser user cannot see. For example, scanning and crawler processes can read these hidden fields. The card generator 72 can include reference to these hidden fields in summary cards 76.

The file system 74 is a system for storing index summary card content references. The file system 74 may be an external component of the index population system 70. The file system 74 may be Web servers.

The index summary cards 76 are files that provide index data for each content instance. Index summary cards 76 provide a summary of the content index 90 and subject index 94. The index summary cards 76 are placed on the file system 74 so that they are subsequently found by search crawlers 36.

The index population system 70 interacts with external components including content 23 of business oriented metadata, a security provider 24, one or more search crawlers 36, one or more search' engines 38 and operators 40. Other embodiments may provide an option in the index summary cards 76 to export an index subset, or a limited copy, to an external search engine 38. In this case, the external search engine 38 has an index corpus 37 of content instances which is a limited copy of the index corpus exported from the index summary cards 76. The index summary cards 76 may allow export of an index subset in an optional single XML file.

The security provider 24 is knowledge of, or method of, determining security access for each content instance. The security provider 24 adds security access control to each summary card 76. The security access control indicates the security of the referenced instance of content 23. The security access control may include digital signatures, certificate revocation lists. Any results returned to the user are constrained by the user's security context. In most cases this means references returned are restricted to content 23 for which the user has rights to execute the default action.

The search crawlers 36 are search engines that index content by “crawling” through content. Examples include Google™ Web Server, Google™ Desktop Search, MSN™ Web Search, MSN™ Desktop Search and other enterprise search tools. The search engines 38 are related search engines that accept queries and provide search results over the index corpus built by the search crawler 36.

FIG. 5 shows the flow of information between components. Referring also to FIG. 6, the process of populating an index corpus is further described.

The index population system 70 identifies content instances 23 that needs to be indexed. The index population system 70 checks a configuration file of source content instance 23 to determine if the source content instance 23 can be added or cannot be added to index summary cards 76. Also, the index population system 70 checks security restrictions on the source content instance 23 to determine if it should include or exclude the source content instance 23. The identified content instances 23 become search targets. The set of identified content instances 23 is given to the card generator 72. The card generator 72 reads the target content instances 23 (160) and creates a representation of each target content instance (162). The card generator 72 includes references to content in sequences of index summary card data, e.g., XML data, that the card generator 72 generates. An external search engine 38 that consumes this data transforms it into useful links, e.g., HTML hyperlinks, for its consumption.

The card generator 72 proceeds to produce one or more index summary cards 76 to represent each target content instance using the references created and summary information of the target content instance (164). The format of each index summary card 76 may be variable. Each index summary card 76 may contain the representation of the relevant content instance in various formats, such as HTML, XML, RDF-XML, plain-text and/or other standard formats. By representing each content instance in various formats, the index population system 70 can increase the possibilities that search crawlers 36 can obtain the maximum amount of usable information from the index summary cards 76.

The card generator 72 gives primary importance to individual terms present in the referenced content instance 23. The card generator 72 places a normalized list of these terms in the index summary card 76. The card generator 72 adds a list of related topics along with a list related concepts and subjects. XML and RDF-XML may be suitably used.

The card generator 72 may also add additional site-specific and index-engine-specific terms, topics, concepts and subjects.

The card generator 72 adds the location information of the referenced content instance to provide viewing or execution references to content instances. Examples of the location information include URLs, files paths and application paths with required parameters.

The index summary cards 76 may also include display text which is used to direct an operator 40 to the referenced content instance 23 when the summary card 76 is displayed.

The card generator 72 retrieves the security restriction applied to each content instance from the security provider 24, and applies it to the index summary card 76 using the appropriate security method. Examples include LDAP, Active Directory, UNIX file security and Windows NT file security.

When the card generator processing is complete, the generated index summary cards 76 are placed on the accessible file system 74 so that they can be found by search crawlers 40 (166).

Once consumed by a search crawler 36, the index corpus 37 is populated to the search engine 38 and referenced content instances are available to users 40 on the related search engine 38. Operator 40 who is searching for content instance 23 sends a search request to the search engine 38. The search engine 38 finds one or more index summary cards 76 that contain matching search terms of the search request. The search engine 38 finds the target content instance 23 referenced by the located index summary cards 76, and redirects the operator 40 to the target content instance 23.

In a different embodiment, index summary cards 76 may be placed on Web Servers. Index summary cards 76 may include RDF-XML. The index population system 70 may store a set of content instances in another limited index corpus, which is subsequently used by the card generator 72 as the source for creating index summary cards 76. The index population system 70 may use XML to export this kind of data to an external search engine 38. RDF is definition of a XML tag set (vocabulary) commonly used to describe subject related data.

The index population system of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements may be embedded in a carrier wave may be transmitted via a communication network. Such a computer readable memory and a computer data signal and/or its carrier are also within the scope of the present invention, as well as the hardware, software and the combination thereof.

While particular embodiments of the present invention have been shown and described, changes and modifications may be made to such embodiments without departing from the scope of the invention. For example, the elements of the index population system are described separately, however, two or more elements may be provided as a single element, or one or more elements may be shared with other components in one or more computer systems.

1. An index population system for populating an index corpus to an external search engine, the index population system comprising:
a card generator for reading business oriented metadata, and for each target content instance in the business oriented metadata, creating a representation of the target content instance, and generating an index summary card for storing the representation of the target content instance, the index summary card being in a format that is consumable by various search engines; and
a file system for storing one or more index summary cards and exposing the index summary cards to an external search engine.

2. (canceled)

3. The index population system as claimed in claim 1 wherein the card generator generates one or more redundant representations of the target content instance, and stores the redundant representations in the index summary card or one or more different index summary cards.

4. The index population system as claimed in claim 1 wherein the card generator includes, in the representation of the target content instance, a reference to the target content instance and summary information of the target content instance including location information of the target content instance.

5. The index population system as claimed in claim 4 wherein the location information of the target content instance includes a URL needed to show the target content instance.

6. The index population system as claimed in claim 4 wherein the card generator includes the location information of the target content instance with an execution reference that forwards a current view to the target content instance.

7. The index population system as claimed in claim 4 wherein the card generator generates the summary information of the target content instance to further include one or more of terms used in the target content instance.

8. The index population system as claimed in claim 7 wherein the card generator includes the one or more terms in a normalized form.

9. The index population system as claimed in claim 4 wherein the card generator generates the summary information of the target content to further include topic hierarchy information, report metadata and/or other information related to the target content instance.

10. The index population system as claimed in claim 1 wherein the card generator generates the index summary cards in one or more formats that are consumable by various search engines.

11. The index population system as claimed in claim 10 wherein the card generator generates the index summary cards in HTML, XML, RDF-XML, plain text and/or other standard format.

12. The index population system as claimed in claim 1 wherein the index population system makes the index summary cards accessible by one or more external search engines to allow the search engines to find the target content instance using the references in the index summary cards.

13. The index population system as claimed in claim 12 wherein the index population system allows a search crawler of a search engine to crawl through and index the index summary cards to build an index corpus for the use by the search engine.

14. A method of populating an index corpus to one or more external search engines, the method comprising the steps of:
reading a target content instance of business oriented metadata;
creating a representation of the target content instance;
generating an index summary card using the representation of the target content instance, the index summary card being in a format that is consumable by various search engines; and
exposing the index summary card to an external search engine.

15. The method as claimed in claim 14 wherein the card generating step generates the index summary card in HTML.

16. The method as claimed in claim 14 wherein the card generating step generates one or more redundant representations of the target content instance.

17. The method as claimed in claim 16 wherein the card generating step comprises the step of including the redundant representations in the index summary card, and/or the step of including the redundant representations in one or more different index summary cards.

18. (canceled)

19. The method as claimed in claim 14 wherein
the card generating step generates multiple index summary cards for multiple target content instances in the business oriented metadata, and
the method further comprises the step of storing the index summary cards in a file system.

20. The method as claimed in claim 19 wherein the exposing step comprises the step of allowing a search crawler of a search engine to crawl through and index the index summary cards to build an index corpus for the use by the search engine.

21. The method as claimed in claim 14 wherein the card generating step comprises the step of generating, in the representation of the target content instance, summary information of the target content instance including location information of the target content instance.

22. The method as claimed in claim 21 wherein the summary information generating step includes a URL needed to show the target content instance the location information of the target content instance with an execution reference that forwards a current view to the target content instance, topic hierarchy information, report metadata and/or other information related to the target content instance.

23. (canceled)

24. The method as claimed in claim 21 wherein the summary information generating step generates the summary information of the target content instance to further include one or more of terms used in the target content instance.

25. The method as claimed in claim 24 wherein the summary information generating step includes the one or more terms in a normalized form.

26. (canceled)

27. The method as claimed in claim 14 wherein the card generating step generates the index summary cards in one or more formats that are consumable by various search engines.

28. The method as claimed in claim 27 wherein the card generating step generates the index summary cards in HTML, XML, RDF-XML, plain text and/or other standard format.

29. The method as claimed in claim 14 further comprising the step of storing the index summary card in a file system.

30-31. (canceled)

32. A computer readable medium storing instructions or statements for use in the execution in a computer of a method of populating an index corpus to one or more external search engines, the method comprising steps of:
reading a target content instance of business oriented metadata;
creating a representation of the target content instance;
generating an index summary card using the representation of the target content instance, the index summary card being in a format that is consumable by various search engines; and
exposing the index summary card to an external search engine.

33. (canceled)
